(19) United States
(12) Patent Application Publication
(10) Pub. No.: US 2013/0267422 A1
(43) Pub. Date: Oct. 10, 2013

(54) COMPOSITION FOR CONTROLLING PLANT DISEASES COMPRISING 3-PENTANOL AS EFFECTIVE COMPONENT

(71) Applicant: Korea Research Institute Of Bioscience And Biotechnology, Daejeon (KR)

(72) Inventors: Choong Min RYU, Daejeon (KR); Hwe Su Yi, Daejeon (KR); Hye Kyung Choi, Daejeon (KR)

(21) Appl. No.: 13/921,359

(22) Filed: Jun. 19, 2013

Related U.S. Application Data
(63) Continuation-in-part of application No. PCT/KR2011/002886, filed on Apr. 21, 2011.

(30) Foreign Application Priority Data
Dec. 23, 2010 (KR) 10-2010-0133116

(51) Int. Cl. A01N 31/02

(52) U.S. Cl. CPC A01N 31/02
USPC 504/353; 568/840

(57) ABSTRACT

The present invention relates to a composition for controlling plant disease comprising 3-pentanol as an effective component, a method of controlling plant disease including treating a plant with 3-pentanol for inducing induced systemic resistance, a formulation for controlling plant disease comprising the composition, a composition for controlling plant disease comprising, as an effective component, Bacillus amyloliquefaciens IN937a strain which produces 3-pentanol, and a method of controlling plant disease including treating a plant with the composition for inducing induced systemic resistance.

### CROSS-REFERENCES TO RELATED APPLICATIONS

The present application is a continuation-in-part application to International Application No. PCT/KR2011/002886, with an International Filing Date of Apr. 21, 2011, which claims the benefit of Korean Patent Application No. 10-2010-0133116, filed in the Korean Intellectual Property Office on Dec. 23, 2010, the entire contents of which are incorporated herein by reference,

### BACKGROUND

1. Technical Field

The present invention relates to a composition for controlling plant diseases comprising 3-pentanol as an effective component, and a method of controlling plant disease including treating a plant with 3-pentanol for promoting induced systemic resistance.

2. Description of the Related Art

Presently, chemically synthesized pesticides are mainly used as a means for inhibition and control of the occurrence of plant pathogens. However, because chemically synthesized pesticides can disturb ecological systems, cause problems with human toxicity due to residual effects, and have a high probability of causing various disorders such as cancer or deformities, their use is rather limited. Thus, researches are actively searching to develop environmentally friendly biological pesticides that can supplant the synthetic pesticides.

Following external attack of a pathogen, a plant exhibits resistance via a supersensitive oxidative burst reaction thereby strengthening the cell wall structure, accumulating antagonistic phytoalexin, and/or producing defense-related proteins. If such resistant mechanisms are exhibited systemically in a plant, the plant can effectively cope with various pathogens including fungi, bacteria, and viruses. These systemically resistant pathways are referred to as induced resistance. Plant growth-promoting rhizobacteria (PGPR) found in plant roots are known to cause induced systemic resistance (ISR) which is another type of induced resistance in plants. Therefore, PGPR are used in studies for the development of environmentally friendly biological pesticides.

Inventors of the present invention collected 18 different volatile organic compounds from a Bacillus amyloliquefaciens IN937a strain known to cause ISR, and determined whether or not the volatile organic compounds exhibited resistance to Xanthomonas axonopodis pv. vesicatoria. A microbial formulation, as described in Korean Patent Registration No. 10-0423121, containing Bacillus amyloliquefaciens CH0104 strain is disclosed.

### SUMMARY

One or more embodiments of the present invention are devised in view of the demand described above. More specifically, the inventors of the present invention screened eighteen different volatile organic compounds from a Bacillus amyloliquefaciens IN937a strain and found that, when a plant is treated with 3-pentanol, bacterial spot disease in pepper and cucumber mosaic virus disease are ameliorated, and thus completed the present invention.

In order to solve the problems described above, one or more embodiments of the present invention provides a composition for controlling plant disease comprising 3-pentanol as an effective component.

The present invention also provides a method of controlling plant disease including treating a plant with 3-pentanol for promoting induced systemic resistance.

The present invention also provides a formulation for controlling plant disease comprising the composition.

The present invention also provides a composition for controlling plant disease comprising, as an effective component, Bacillus amyloliquefaciens IN937a strain which produces 3-pentanol.

The present invention also provides a method of controlling plant disease including treating a plant or seed with the composition for promoting induced systemic resistance.

According to the present invention, the composition for controlling plant disease comprising 3-pentanol as an effective component is productive in controlling bacterial spot disease in pepper and cucumber mosaic virus disease, and thus it is believed to be useful for improving yields of pepper. Furthermore, the composition of the present invention is highly safe, meaning it is environmentally friendly and has no toxicity in animals such as humans.

### BRIEF DESCRIPTION OF DRAWINGS

FIGS. 1A and 1B illustrate the effect of the eighteen different volatile organic compounds from Bacillus amyloliquefaciens IN937a strain on plant ISR against Xanthomonas axonopodis pv. vesicatoria under greenhouse conditions. In FIG. 1A, eighteen different volatile organic compounds at two different concentrations (i.e., 10 μM and 100 nM) were screened against disease occurrence rate and In FIG. 1B, four selected volatile organic compounds exhibits the greatest ISR effect. The positive control plant was treated with 0.5 mM benzothiadiazole (BTH). The disease occurrence rate (i.e., 0 to 5) as an indicator of ISR was measured on Day 7 following inoculation of pathogen (i.e., 0: no symptoms; 5: severe symptoms of necrosis).

FIGS. 2A and 2B illustrate the effect of 3-pentanol on plant ISR against Xanthomonas axonopodis pv. vesicatoria under field conditions at different time points. The ISR effect of 3-pentanol was measured on Day 10, Day 20, Day 30, and Day 40 after seedling transplantation. The positive control plant was treated with 0.5 mM BTH. The disease occurrence rate (i.e., 0 to 5) as an indicator of ISR was measured on Day 10 following inoculation of pathogen. FIG. 2A shows photographic images which were taken on Day 0 to Day 40 following transplantation. FIG. 2B shows the results to compare the disease occurrence rate at 10 days post treatment (dpt), 20 dpt, 30 dpt, and 40 dpt (i.e., 0: no symptoms; 5: severe symptoms of necrosis).

FIGS. 3A through 3D illustrate expression of the defense-related genes PR1 and PR4 induced by 3-pentanol following inoculation of pathogen to pepper. Expression of the defense signal transduction related genes PR1 and PR4 at 10 dpt (FIG. 3A), 20 dpt (FIG. 3B), 30 dpt (FIG. 3C), and 40 dpt (FIG. 3D) was determined by quantitative RT-PCR. Relative RNA levels were calibrated and normalized to the level of CaActin mRNA. The samples were collected 6 hours post inoculation of pathogen. The positive control group plant was treated with BTH.

FIGS. 4A through 4D illustrate the effect of 3-pentanol on growth and yield of pepper under field conditions. The positive control group plant was treated with 0.5 mM BTH. Photographic images of FIG. 4A and FIG. 4B were taken three months after transplantation. FIG. 4C shows the length of new shoot and (D) yield of pepper measured three months after the treatment with 3-pentanol. “a”, “b”, and “c” represent a statistically significant difference when compared with a control plant group treated with water (P=0.05).

FIGS. 5A through 5C illustrate the effect of 3-pentanol on ISR against naturally occurring plant diseases under field conditions. FIG. 5A illustrates the effect of 3-pentanol on cucumber mosaic virus (CMV) disease three months after the treatment, FIG. 5B illustrates the symptoms of the viral disease (the photographic image was taken three months after the naturally occurring plant disease), and FIG. 5C illustrates the effect of 3-pentanol on bacterial leaf spot disease three months after treatment. The positive control group plant was treated with 0.5 mM BTH. The disease occurrence rate (i.e., 0 to 5) as an indicator of ISR was measured three months after transplantation (i.e., 0: no symptoms; 5: severe symptoms of necrosis).

FIG. 6 illustrates the effect of Bacillus amyloliquefaciens IN937a strain on ISR of a plant against Xanthomonas axonopodis pv. vesicatoria under greenhouse conditions. The positive control group plant was treated with 0.5 mM BTH. The disease occurrence rate (i.e., 0 to 5) as an indicator of ISR was measured on Day 7 after the inoculation of pathogen (i.e., 0: no symptoms; 5: severe symptoms of necrosis).

FIG. 7 illustrates induction of systemic resistance by 1 mM 3-pentanol against Pseudomonas syringae pv. lachrymans. The severity of symptoms was scored from 0 to 5 as follows: 0, no symptoms; 1, yellowish color; 2, chlorosis only; 3, partial necrosis and chlorosis; 4, necrosis of the inoculated area and expanded chlorosis; and 5, complete necrosis of the inoculated area. Disease severity of cucumber treated with 3-pentanol was assessed 7 days after infection with P. syringae pv. lachrymans. Water and 1 mM BTH were used as negative and positive controls, respectively. Bars representing the mean, annotated by different letters, are significantly different at P=0.05 according to the LSD test. Error bars indicate the standard error (n=16).

FIGS. 8A and 8B illustrate that 3-pentanol confers induced resistance against aphids in cucumber: (a), Nymph number; (b), Adult number. Bars represent the mean±SE (sample size, n=12 replications per treatment). Means in columns followed by different letters are significantly different at P=0.05 according to the LSD test.

### DETAILED DESCRIPTION

In order to achieve the purpose of the invention, the present invention provides a composition for controlling plant disease comprising 3-pentanol as an effective component. Preferably, 3-pentanol may originate from, but its origin is not limited to, a Bacillus amyloliquefaciens IN937a strain.

In one embodiment, the plant disease may be, but not limited to, either a bacterial disease or a viral disease. In one embodiment, the bacterial disease is preferably, but not limited to, bacterial spot disease in pepper. In one embodiment, the viral disease is, but not limited to, cucumber mosaic virus disease.

The Bacillus amyloliquefaciens IN937a strain, according to the present invention, is known to have an ability to promote induced systemic resistance (ISR) as described in, Ryu et al., J Microbiol Biotechnol 17 (2), 280-286, 2007), and is hereby incorporated herein in its entirety.

The composition for controlling plant disease, according to the present invention, can be prepared in the form of, but not limited to, a directly sprayable solution, powder, suspension, and/or in a highly concentrated aqueous, oily, or similar suspension, dispersion, emulsion, oily dispersion, paste, dust, scatter material, or granules. In addition, the composition for controlling plant disease may be used by spraying, atomization, scattering, or pouring. The application form depends on the desired purpose, and in all cases, the composition of the present invention should have a fine and homogenous distribution.

The present invention further provides a formulation for controlling plant disease comprising the composition. The composition for controlling plant disease, according to the present invention, can be prepared in various formulations. For example, the preparation can be produced by adding a solvent and/or a carrier. Other examples, such as inactive additives and surface active substances, (e.g., an emulsifier and a dispersing agent), can be added to the preparation. Preferred examples of surface active substances include, but are not limited to, aromatic sulfonic acids (e.g., lignosulfonic acid, phenol-sulfonic acid, naphthalene- and dibutylnaphthalene sulfonic acid), fatty acids, alkyl- and alkyl aryl sulfonates, alkyl lauryl ethers, aliphatic alcohol sulfates of alkali metals or alkaline earth metals, ammonium salts, hexa-, hepta-, and octa-decanol sulfates, salts of aliphatic alcohol glycol ethers, naphthalene sulfonates and derivatives thereof, condensates of formaldehyde, naphthalene or naphthalene sulfonic acids, condensates of phenol and formaldehyde, polyoxyethylene octyl phenol ethers, ethoxylated isooctyl-, octyl- or nonyl phenol alkyl phenyl or tributyl phenyl polyglycol ethers, alkyl aryl polyether alcohols, isotridecyl alcohols, aliphatic alcohol/ethylene oxide condensates, ethoxylated castor oils, polyoxyethylene alkylethers or polyoxypropylenes, lauryl alcohol polyglycol ether acetate, sorbitol esters, lignin-sulfite waste, and methyl cellulose.

In one embodiment, the composition can be prepared with a solid carrier. Solid carriers can include, but are not limited to, substances which are porous and agriculturally amenable. Examples of solid carriers include, but not limited to, earth minerals (e.g., silica, silica gel, silicate, talcum, kaolin, limestone, lime soda, chalk, bowl, red clay, clay, diatomite, dolomite, calcium sulfate, magnesium sulfate, and other pulverized synthetic materials), fertilizers (e.g., ammonium sulfate, ammonium phosphate, ammonium nitrate, and urea), plant products (e.g., cereal powder, tree bark powder, wood meal, and nut shell powder), and cellulose powder. In addition, the solid carrier may be used either singly or in combination of two or more types.

The composition for controlling plant disease, according to the present invention, can be used for, but not limited to, irrigation, immersion, leaf sprays, seed sterilization, or sterilization of farming equipment, and the like.

In one embodiment, the composition for controlling plant disease, according to the present invention, whereby 3-pentanol is an effective component, may be used singularly. In another embodiment, the composition for controlling plant disease, according to the present invention, whereby 3-pentanol is an effective component, may be used in combination with two or more chemicals for inducing resistance to antibacterial or antiviral substances. In another embodiment, the composition for controlling plant disease, according to the present invention, may be used as a mixture with a spreading agent, a penetration agent, or a surface active agent to aid in the enhancement of absorption into crops and/or enhance the effectiveness of the composition.

The present invention further provides a method of controlling plant diseases including, but not limited to, treating a plant with 3-pentanol for promoting induced systemic resistance. In one embodiment, 3-pentanol preferably originates, but its origin is not limited to, from a Bacillus amyloliquefaciens IN937a strain. In another embodiment, the plant disease may be, but not limited to, a bacterial disease. In another embodiment, the plant disease may be, but not limited to, a viral disease. In another embodiment, the bacterial disease may preferably be, but not limited to, bacterial spot disease in pepper. In another embodiment, the viral disease may preferably be, but not limited to, cucumber mosaic virus disease.

The present invention further provides a composition for controlling plant disease comprising, as an effective component, a Bacillus amyloliquefaciens IN937a strain which produces 3-pentanol. The plant disease may be, but not limited to, either a bacterial disease or a viral disease. In one preferred embodiment, the bacterial disease may be, but not limited to, bacterial spot disease in pepper. In another preferred embodiment, the viral disease may be, but not limited to, cucumber mosaic virus disease. In another preferred embodiment, the above described formulations incorporating solvents, carriers, and auxiliary agents can be effectively used in producing the composition in acceptable dosing forms.

The present invention also provides a method of controlling plant disease including treating a plant with the above described composition for inducing induced systemic resistance. In one embodiment, the plant disease may be, but not limited to, a bacterial disease. In another embodiment, the plant disease may be, but not limited to, a viral disease. In one preferred embodiment, the bacterial disease may be, but not limited to, bacterial spot disease in pepper. In another preferred embodiment, the viral disease may be, but not limited to, cucumber mosaic virus disease.

Provided herein are non-limiting examples used to illustrate how those of ordinary skill in the art may make and use the present invention. These examples are not intended to limit the scope of the invention as contemplated by the inventors. Amounts, temperatures, and times are approximate.

Materials and Methods

Determination of ISR Properties Under Greenhouse Conditions

In order to determine the ISR properties of the previously selected, eighteen different volatile organic compounds from the Bacillus amyloliquefaciens IN937a strain, young pepper was grown for 3 to 4 weeks after seeding and irrigated, with the compounds present, in concentrations of 10 μM or 100 nM in 50 ml volumes. One week following irrigation treatment, the plant was exposed to Xanthomonas axonopodis pv. vesicatoria at a concentration of 10⁷ CFU/ml. Symptoms of disease were observed five to seven days later, and the level of disease was measured based on a scale from 0 to 5, as described above. In a second screening, four volatile substances, selected from the first screening, were incorporated into the irrigation treatment at concentrations of 1 mM, 10 μM, 0.1 μM, and 1 nM. After exposure to pathogen, symptoms of disease were observed.

Determination of ISR Properties Under Field Conditions

3-Pentanol, having shown ISR properties, was used for subsequent direct applications. Pepper seeds were purchased from Heungnong Jongmyo (breed; Bugang). The surface of the seeds were sterilized for 5 minutes using 1% sodium hypochlorite and rinsed with sterilized water for 5 min. The surface sterilized seeds were allowed to germinate on MS medium containing an appropriate amount of moisture. Germinated seeds, without m having any contamination, were planted in a 50-hole pot (28×54×6 cm) filled with soil for horticultural use (Punong Co., Ltd, Korea) and cultivated for six weeks in a greenhouse at 20 to 30° C. Six weeks after seeding and upon growth of seven to eight main leaves, 1 mM 3-pentanol was diluted to a volume of about 3 liters with sterilized water and poured into the 50-hole pot dish. In order to have effective soaking of the immersion solution in the soil and roots of the plant, immersion was carried out over about 24 hours. After 24-hour immersion, the young pepper plants were transplanted into a field (i.e., Chungyong-Li, Gaduk-Myon, Chungwon-Gun, Chungchongbuk-Do, South Korea 36°32′27.26″ North and 127°33′07.81″ East). The burrow to burrow distance was 1.2 m and the field was about 12.5 m to ensure the treatment areas were evenly mixed with each other. Twenty days after the final transplantation into the field, a secondary application of 1 mM 3-pentanol diluted to a volume of about 3 liters with sterilized water, was applied as 100 mL irrigation treatments for each. The test method used was as follows: after final transplantation, using a syringe, Xanthomonas axonopodis pv. vesicatoria at the concentration of 10⁷ CFU/ml was exposed to the backside of the pepper leaf at intervals of 10 days until Day 40. Responses were then examined seven to ten days after exposure. The bacterial inoculant has been cultured for 48 hours at 30° C. after adding antibiotics of Rifampicin (100 μg/ml) to a solid medium. The control group received zero treatment and the treatment group received four applications. The disease occurrence rate was determined based on comparison and observation at 10 day intervals until Day 40. The severity of symptoms was scored as in Yang et al. 2009, Plant Pathol. J. 25 (4): 389-399, which is hereby incorporated in its entirety, as follows: 0=No symptoms, 1=weak whitening symptoms, 2=whitening symptoms, 3=whitening symptoms and weak necrosis, 4=necrosis, and 5=severe necrosis symptoms.

Expression Analysis of Resistant Genes

Expression of PR1 and PR4 genes related to the disease resistance of pepper were examined based on quantitative real time-polymerase chain reaction (qRT-PCR). The sequences of the primers used are as follows.

(SEQ ID NO: 1)
PR1F: 5′-ACTTGCAATTATGATCCACC-3′
(SEQ ID NO: 2)
PR1R: 5′-ACTCCAGTTACTGCACCATT-3′
(SEQ ID NO: 3)
PR4F: 5′-AACTGGGATTGAGAACTGCCAGC-3′
(SEQ ID NO: 4)
PR4R: 5′-ATCCAAGGTACATATAGAGCTTCC-3′

Following bacterial exposure to the backside of a pepper leaf, the pepper leaf was cut using scissors at 0 hours and at 6 hours and stored in liquid nitrogen. RNA isolation began with the pepper leaf being ground in liquid nitrogen using a mortar and pestle, The RNA was then extracted from the pepper leaf by using TRIzol Reagent (Invitrogen Life Technologies). The extracted RNA was subjected to reverse transcription using M-MLV reverse transcriptase (Enzynomics). qRT-PCR was employed using the cDNA obtained from the reverse transcription (qRT-PCR conditions: initial denaturation for 10 mint at 95° C., and 40 cycles of DNA synthesis (30 sec at 95° C., 60 sec at 55° C., and 30 sec at 72° C.), and elongation reaction for 1 min at 72° C. as a final step).

Plant Growth and Chemical Treatment

Cucumber plants (Cucumis sativus L. cv. backdadagi) were cultivated in an open field under natural conditions. For greenhouse experiments, seeds were directly planted in pots containing soilless medium (Punong Co. Ltd., Gyeongju, Korea) in a 24 hole plug tray under greenhouse condition. The germinated seedlings were transplanted into large pots (diameter=30 cm; height=30 cm). Chemical treatments to elicit induced resistance in cucumber were carried out. Briefly, the 14 day old cucumber seedlings were treated by direct drench application of 50 mL solution of 1 mM 3-pentanol. 3-pentanol bought from Sigma-Aldrich Co. was dissolved in distilled water before application. Treatments with 1 mM benzothiadiazole (BTH) and water were used as positive and negative controls, respectively.

Assessment of Angular Leaf Spot Disease and Aphid Infestation

For pathogen challenge, a culture of the compatible bacterial pathogen Pseudomonas syringae pv. lachrymans (OD600=1 in 10 mM MgCl₂) was spray-challenged on cucumber leaves until run-off at 7 days after the drench application of chemicals to roots at 21 days after seeding. The severity of symptoms was scored from 0 to 5 as follows: 0, no symptoms; 1, less than 20% diseased area; 2, 21%-40% diseased area; 3, 41%-60% diseased area; 4, 61%-80% diseased area; and 5, more than 81% diseased area of the entire leaf Bacterial pathogens were cultured overnight at 28° C. in King's B medium supplemented with the appropriate antibiotics (100 μg/mL). As a positive control, roots were treated with 1 mM BTH. The experiment had a completely randomized design, with ten replications, and was independently repeated four times. To investigate whether the 3-pentanol elicited plant immunity to aphid feeding, numbers of naturally occurring aphids (in 2011, Daejeon, Korea) were counted. Application of 1 mM BTH was used as a positive control. The total numbers of nymph and adult aphids were counted at 34 days after seeding. The experiments were repeated with similar results.

Statistical Analysis

Analysis of variance for experimental datasets was performed using JMP software (version 5.0; SAS Institute, Inc., Cary, N.C., USA). Significant effects of treatment were determined by the magnitude of the F value (P=0.05). When a significant F test was obtained, separation of means was accomplished by Fisher's protected LSD at P=0.05.

### EXAMPLE 1

### Results of Determination of ISR Properties Under Greenhouse or Field Conditions

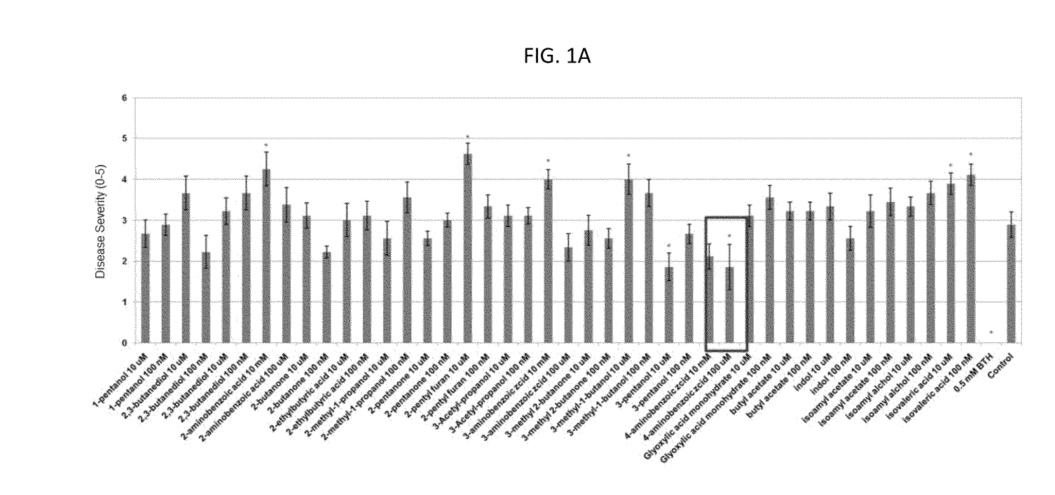

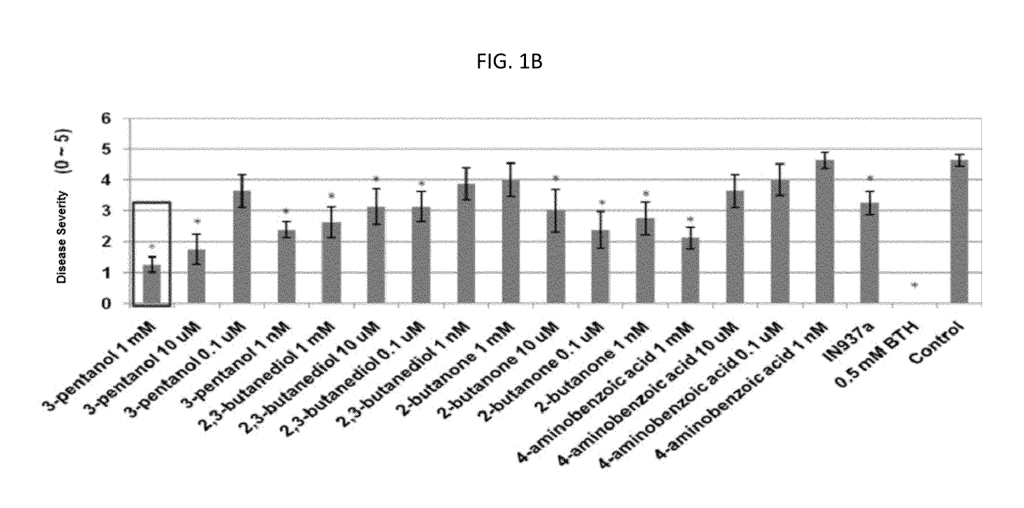

Carrying out the screening in a greenhouse (i.e., in duplicate) using 18 different volatile organic compounds from a Bacillus amyloliquefaciens IN937a strain (FIGS. 1A and 1B), substances exhibiting resistance to bacterial spot disease in pepper were first selected (FIG. 1A), and as a result, 1 mM 3-pentanol was finally selected (FIG. 1B).

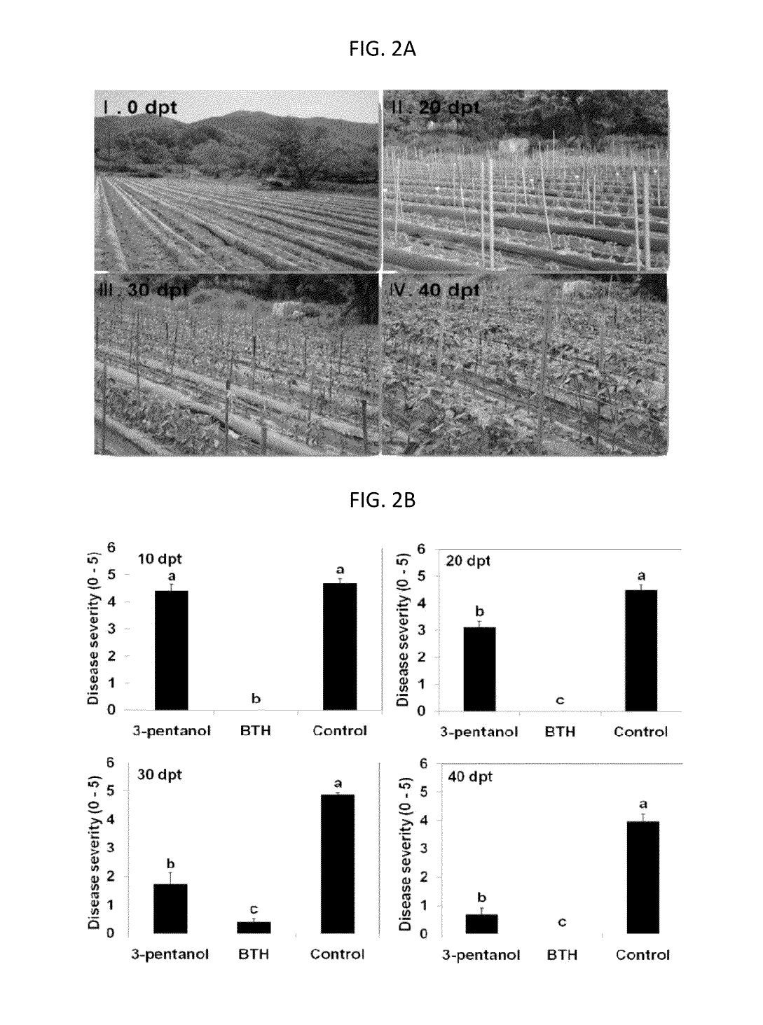

Under field conditions, the ISR property of 3-pentanol against bacterial spot disease in pepper was examined (FIGS. 2A and 2B). Ten days after the final transplantation, the group treated with 3-pentanol showed no difference compared to the control group (FIG. 2B). Twenty days after the final transplantation, the disease level was less than the control group, although the effect was lower than that of BTH (i.e., a positive control group) (FIG. 2B). Treatment with 3-pentanol was additionally carried out and determined at thirty days and at forty days after the final transplantation (FIG. 2B). Results at thirty days and forty days showed higher resistance to the disease compared to the control group.

### EXAMPLE 2

### Expression Analysis of Resistant Gene

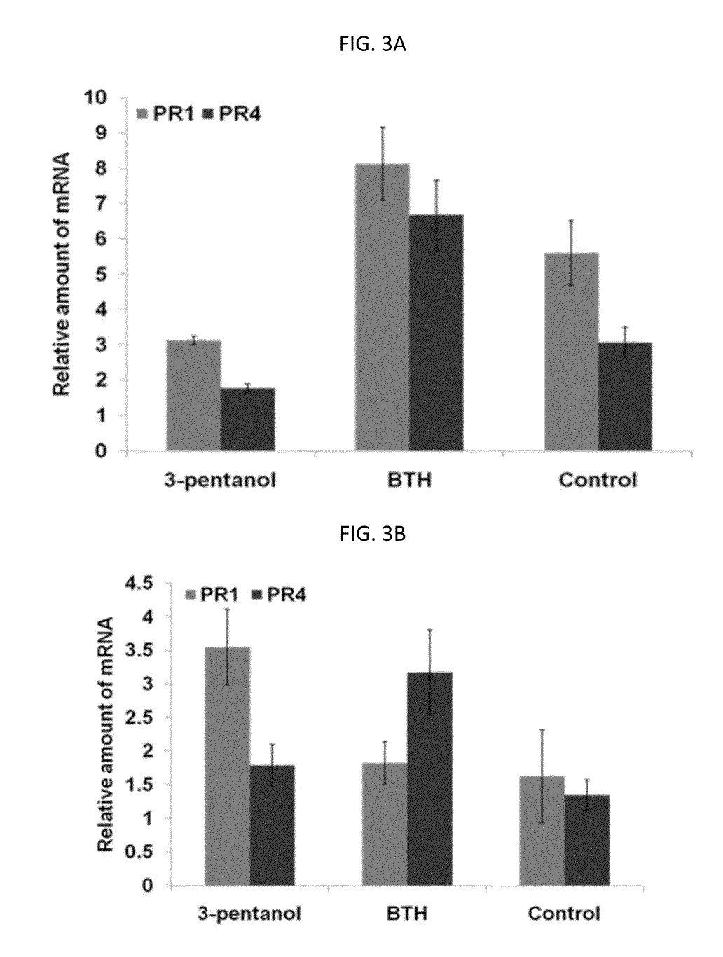

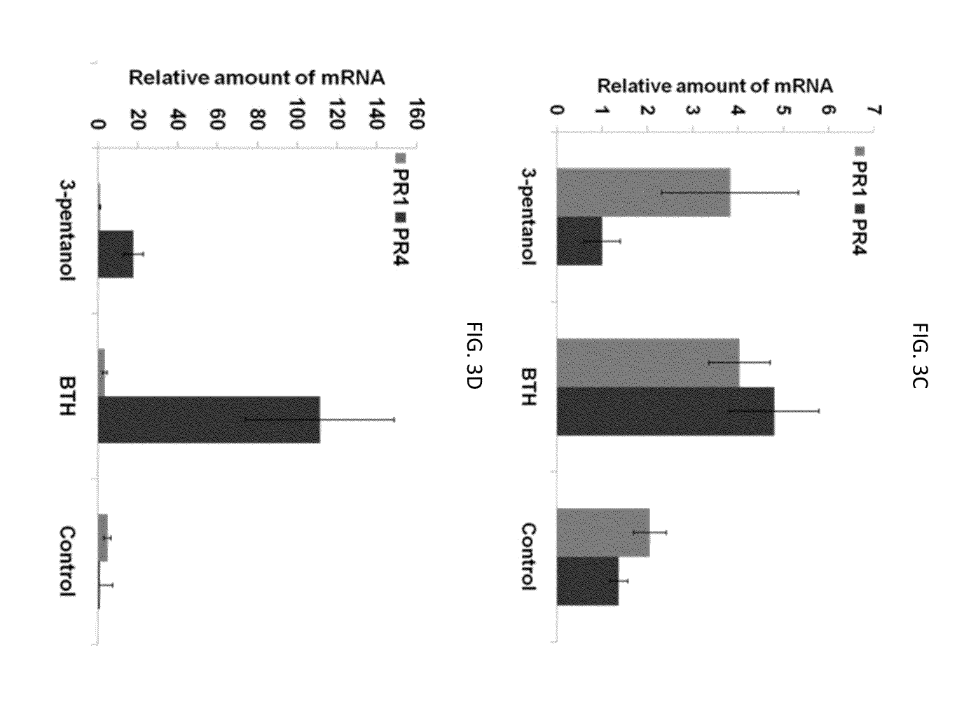

Expression of PR1 and PR4 genes were examined six hours after the inoculation of pathogen until Day 10 through Day 40 following final transplantation (FIGS. 3A-3D). On Day 10 after the final transplantation, the group treated with 3-pentanol exhibited lower expression level of PR gene compared to the control group. However, starting from Day 20 after the transplantation, the expression of PR gene in the group treated with 3-pentanol was found to be the same or higher than that of the control group.

### EXAMPLE 3

### Effect of 3-Pentanol on Growth and Yield of Pepper

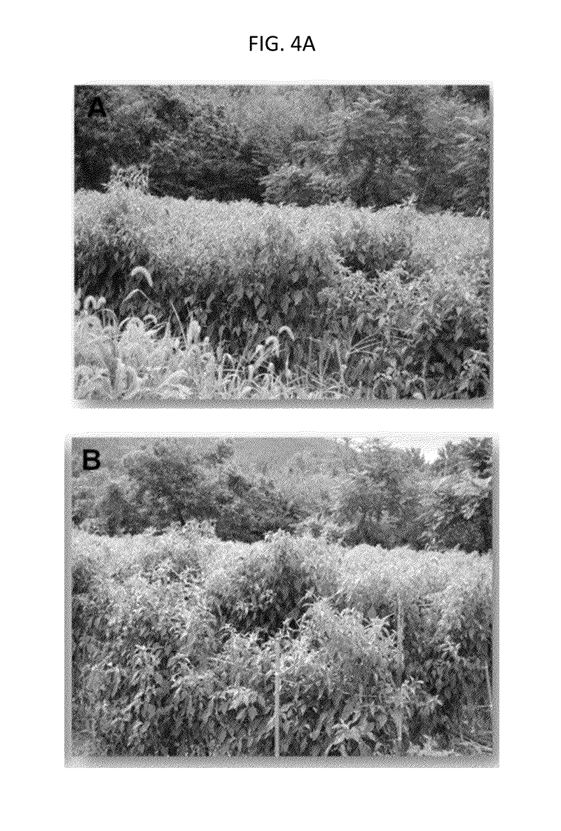

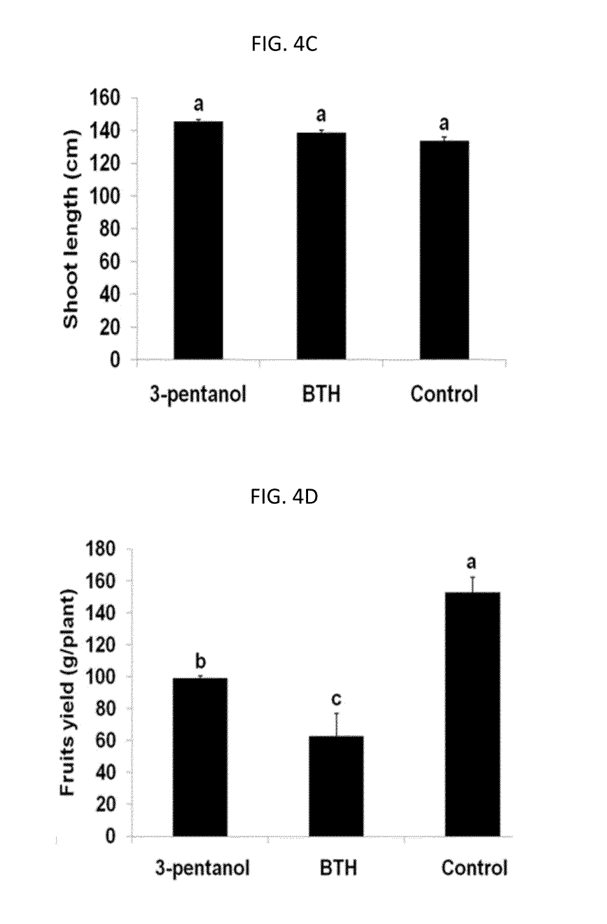

After the final transplantation, growth and yield were determined for each treatment group during the plant harvest period (FIGS. 4A-4D). In terms of plant growth, there was no difference between the control group and the group treated with 3-pentanol. In terms of yield, however, the yield in the group treated with 3-pentanol was lower than the control group, but the yield in the group treated with 3-pentanol was higher than that of BTH (FIG. 4D).

### EXAMPLE 4

### Effect of 3-Pentanol on Naturally Occurring Disease

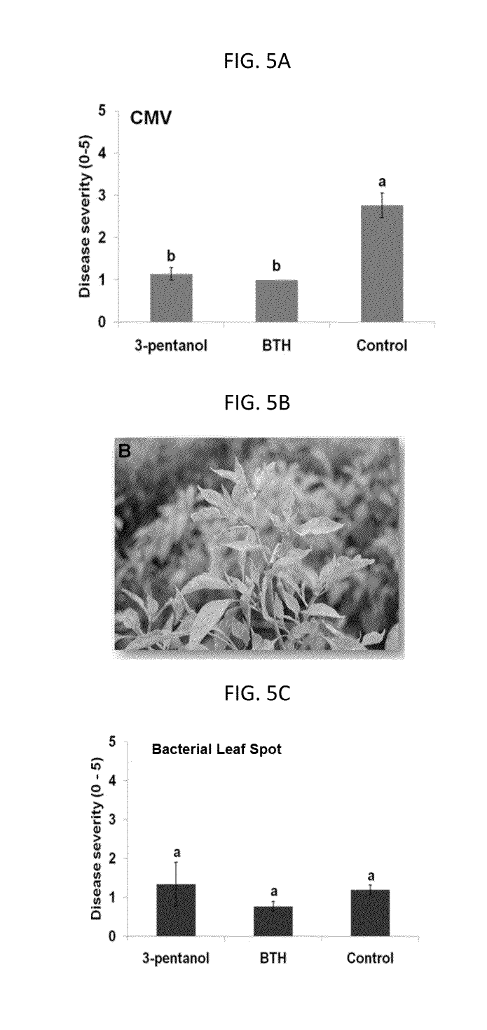

After confirming the resistance inducing ability of 3-pentanol against plant disease, resistance levels against a naturally occurring disease was determined three months after the final transplantation (FIGS. 5A-5C). At the initial stage of the transplantation, cucumber mosaic viruses naturally proliferate in large amounts. The resistance to cucumber mosaic virus was significantly increased in the group treated with 3-pentanol compared to the control group, and the level of increased resistance was found to be almost the same as BTH (FIG. 5A). However, it was found that the resistance to bacterial leaf spot disease is not different among three treatment groups (FIG. 5C)FIG.

### EXAMPLE 5

### ISR Effect of Bacillus amyloliquefaciens IN937a Strain on Bacterial Spot Disease in Pepper Under Greenhouse Conditions

Using a 1 mL syringe, Xanthomonas axonopodis pv. vesicatoria pathogen with a concentration of 10⁷ CFU/ml was exposed to the backside of the pepper leaf, and the response exhibited was recorded seven to ten days following exposure. The bacterial inoculant was cultured for 48 hours at 30° C. after adding antibiotics of Rifampicin (100 μg/ml) to a solid medium.

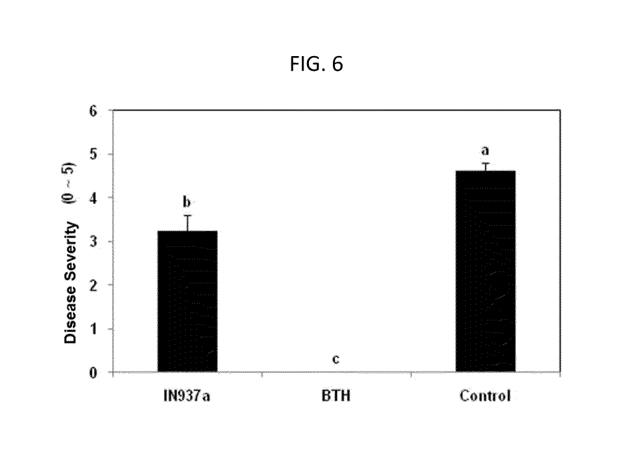

Seven days post-inoculation of pathogen, the ISR effect of a Bacillus amyloliquefaciens IN937a strain was examined The results, compared to the control group, indicated the disease resistance was higher in the group treated with the Bacillus amyloliquefaciens IN937a strain, although disease resistance was lower than that of BTH (FIG. 6).

### EXAMPLE 6

### 3-Pentanol Elicits Induced Resistance Against Pseudomonas syringae and Reduced Numbers of Aphids

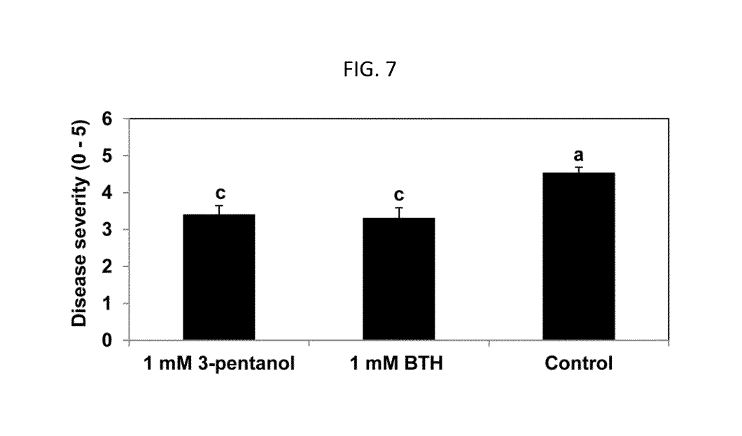

Drench application of 3-pentanol resulted in a reduction of disease severity in cucumber under open field conditions at 28 days post seeding (dps) (i.e., 7 days after spray-challenge of P. syringae pv. Lachrymans) (FIG. 7). The treatment of cucumber plants with 1 mM 3-pentanol resulted in 24% less symptom severity, compared to water control (FIG. 7). Plants treated with BTH (i.e., employed as a positive control), showed similar levels of reduced disease severity compared to plants treated with 1 mM 3-pentanol.

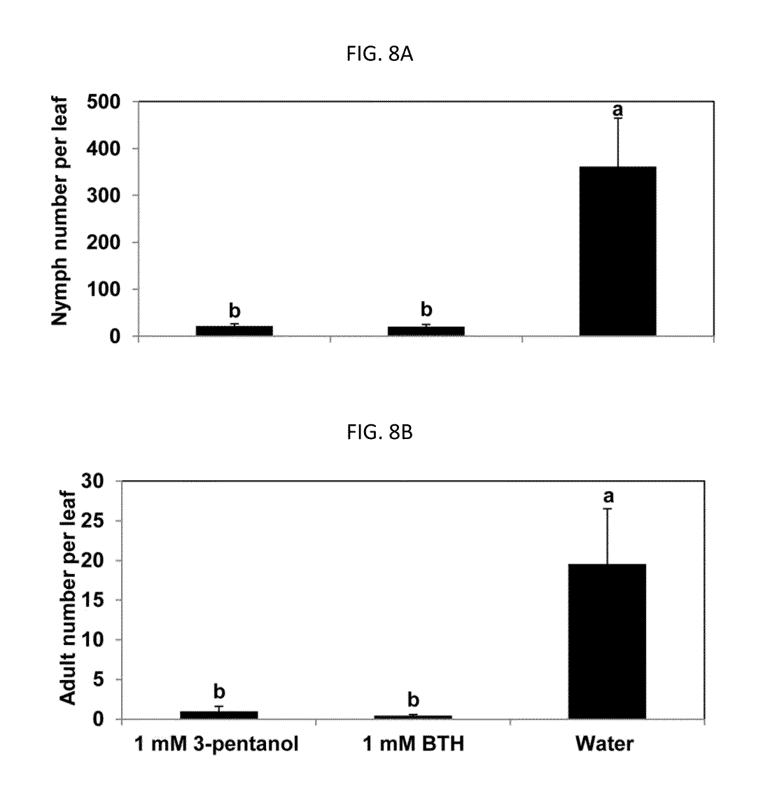

At 34 dps, the number of aphids significantly decreased in 3-pentanol treatments compared with the control (FIGS. 8A and 8B). The control plants contained 361 nymphs and 19 adults per leaf (FIGS. 8A and 8B, respectively). Plants that were soil drenched with 1 mM 3-pentanol exhibited 21 nymphs (FIG. 8A) and 1.0 adult aphids (FIG. 8B). BTH treatment decreased the number of aphids on the plants as well, with 20 nymphs (FIG. 8A) and 0.4 adult aphids per leaf (FIG. 8B).

What is claimed is:

1. A composition for controlling plant disease comprising 3-pentanol as an effective component.

2. The composition according to claim 1, wherein 3-pentanol originates from a Bacillus amyloliquefaciens IN937a strain.

3. The composition according to claim 1, wherein the plant disease is either a bacterial disease or a viral disease.

4. The composition according to claim 3, wherein the bacterial disease is bacterial spot disease in pepper.

5. The composition according to claim 3, wherein the viral disease is cucumber mosaic virus disease.

6. A method of controlling plant disease including treating a plant with 3-pentanol for promoting induced systemic resistance.

7. The method according to claim 6, wherein 3-pentanol originates from said Bacillus amyloliquefaciens IN937a strain.

8. The method according to claim 6, wherein the plant disease is either a bacterial disease or a viral disease.

9. The method according to claim 8, wherein the bacterial disease is bacterial spot disease in pepper.

10. The method according to claim 8, wherein the viral disease is cucumber mosaic virus disease.

11. A formulation for controlling plant disease comprising the composition of claim 1.

12. A composition for controlling plant disease comprising, as an effective component, said Bacillus amyloliquefaciens IN937a strain which produces 3-pentanol.

13. The composition for controlling plant disease according to claim 12, wherein the plant disease is either a bacterial disease or a viral disease.

14. The composition for controlling plant disease according to claim 13, wherein the bacterial disease is bacterial spot disease in pepper.

15. The composition for controlling plant disease according to claim 13, wherein the viral disease is cucumber mosaic virus disease.

16. A method of controlling plant disease including treating a plant with the composition of claim 12 for promoting induced systemic resistance.

17. The method of controlling plant disease according to claim 16, wherein the plant disease is either a bacterial disease or a viral disease.

18. The method of controlling plant disease according to claim 17, wherein the bacterial disease is bacterial spot disease in pepper.

19. The method of controlling plant disease according to claim 17, wherein the viral disease is cucumber mosaic virus disease.


SEQUENCE LISTING (4 sequences)

SEQ ID NO: 1 - DNA, 20 bp, Artificial Sequence
  PR1F primer
acttgcaattatgatccacc

SEQ ID NO: 2 - DNA, 20 bp, Artificial Sequence
  PR1R primer
actccagttactgcaccatt

SEQ ID NO: 3 - DNA, 23 bp, Artificial Sequence
  PR4F primer
aactgggattgagaactgccagc

SEQ ID NO: 4 - DNA, 24 bp, Artificial Sequence
  PR4R primer
atccaaggtacatatagagcttcc